(19) United States
(12) Patent Application Publication
(10) Pub. No.: US 2013/0020927 A1
(43) Pub. Date: Jan. 24, 2013

(54) PLASMA DISPLAY PANEL AND METHOD FOR PRODUCING THE SAME

(71) Applicants: Yayoi Okui, Osaka (JP); Masahiro Sakai, Kyoto (JP); Yusuke Fukui, Osaka (JP)

(72) Inventors: Yayoi Okui, Osaka (JP); Masahiro Sakai, Kyoto (JP); Yusuke Fukui, Osaka (JP)

(73) Assignee: PANASONIC CORPORATION, Osaka (JP)

(21) Appl. No.: 13/637,248

(22) PCT Filed: May 13, 2011
(86) PCT No.: PCT/JP2011/002670

§ 371 Date: Sep. 25, 2012

(30) Foreign Application Priority Data
May 13, 2010 (JP) 2010-111199

(51) Int. Cl. H01J 17/49; H01J 9/26

(52) U.S. Cl. 313/485; 445/25

(57) ABSTRACT

There is provided a PDP including a front substrate and a rear substrate. The front substrate and the rear substrate are disposed via discharge spaces. The discharge spaces are filled with a discharge gas. In the discharge spaces or in a space permeable to the discharge spaces, a copper-ion-exchanged zeolite adsorbent is disposed which is in an activated state.

### TECHNICAL FIELD

The present invention relates to a plasma display panel and a method of manufacturing thereof and, more particularly, to technologies for improving a discharge gas atmosphere in the insides of discharge spaces.

### BACKGROUND ART

A plasma display panel (hereinafter abbreviated to as “PDP”) is broadly grouped into an AC-type and a DC-type, based on its driving method. In terms of the type of discharge, the panel is grouped into two, i.e. a surface-discharge type and an opposed-discharge type. Under present circumstances, an AC-type PDP with a three-electrode structure is in the mainstream, from viewpoints of high definition, a large screen, and easy manufacturing.

In each of the surface-discharge type PDPs, there are disposed a pair of substrates (front substrate and rear substrate) facing each other via a discharge space, and barrier ribs to partition the discharge space into plural parts, with at least the front substrate being transparent. In the front substrate, a plurality of display electrode pairs are formed. In the rear substrate, a plurality of data electrodes are disposed. Barrier ribs are formed so as to separate the respective data electrodes. Between adjacent barrier ribs, a phosphor layer of any of red, green, and blue colors is formed. Discharge cells are each formed at a position where one display electrode pair intersects one data electrode via the discharge spaces. When driving, each of the discharge cells generates short-wavelength vacuum ultraviolet rays, in its discharge space, which excite the phosphor to emit visible light, i.e. any of red, green, and blue colors, which passes through the front substrate to provide an image display (a color display).

Such the PDPs receive much attention among flat panel displays (FPDs) for some reasons including their capability of a high speed display, a large viewing angle, an easily-upsized screen, and high display quality due to self-luminous performance, compared with liquid crystal displays (LCDs). The PDPs are used in a variety of applications such as a display apparatus used at public places where many people gather, and a display apparatus for large-screen images in households.

In the inside of the display apparatus, the PDP is held on the front side of a chassis composed of metal such as aluminum. On the rear side of the chassis, a circuit board is disposed which configures a driver circuit to drive the PDP to emit light, thereby configuring a module (see Patent Literature 1).

### CITATION LIST

### Patent Literature

Patent Literature 1: Japanese Patent Unexamined Publication No. 2003-131580

### SUMMARY OF THE INVENTION

### Problem to be Solved by the Invention

In discharge spaces of a PDP, an inert gas (a discharge gas) for generating vacuum ultraviolet rays is filled at a predetermined pressure. The composition of the discharge gas is important because it influences a discharge voltage. That is, contamination of the discharge spaces by impurity gases such as carbon dioxide (CO₂) and water vapor (H₂O) poses a problem that it will induce variations in the discharge voltage. This causes the discharge voltage of the PDP to be nonuniform, leading to a decrease in image display quality.

Moreover, there is a method in which a partial pressure of Xe of the discharge gas is set high so as to improve light-emission efficiency of the PDP; however, it increases the intensity of discharge, which thereby increases the amount of emission of the impurity gases, leading to a possible decrease in image display quality.

The present invention is made in view of the above problems, and an object of the present invention is to provide a PDP capable of being improved in the nonuniformity in the discharge voltage and a method of manufacturing thereof, by disposing an adsorbent capable of adsorbing impurity gases that are possibly released in the discharge spaces.

### Means for Solving the Problem

To overcome the above problems, the present invention is directed to provide a PDP including a front substrate and a rear substrate in such a manner that: The front substrate is such that there are formed: a plurality of display electrode pairs on the surface of the substrate; a first dielectric layer covering each of the display electrode pairs; and, in addition, a protective layer on the first dielectric layer. The rear substrate is such that there are formed: the plurality of data electrodes on the surface of the substrate; a second dielectric layer covering each of the data electrodes; in addition, a plurality of barrier ribs on the second dielectric layer; and phosphor layers directly or indirectly on the side surfaces of the barrier ribs and on the surface of the second dielectric layer. The front substrate and the rear substrate are disposed via discharge spaces, with one face with the protective layer disposed thereon facing another face with the barrier ribs disposed thereon. The discharge spaces are filled with a discharge gas. In the discharge spaces or in a space permeable to the discharge spaces, a copper-ion-exchanged zeolite adsorbent is disposed which is in an activated state.

### Effects of the Invention

In the PDP according to the present invention, the nonuniformity in the discharge voltage can be improved by disposing the adsorbent capable of adsorbing the impurity gases that are released in the discharge spaces due to discharges.

### BRIEF DESCRIPTION OF DRAWINGS

FIG. 1 is an assembly view showing a configuration of PDP 1.

FIG. 2 is a schematic view showing a relationship between respective electrodes of PDP1 and drivers.

FIG. 3 is a cross-sectional view of PDP 1, showing a location at which adsorbent 39 is disposed (powder on the surface of a protective layer).

FIG. 4 is a flow diagram showing a part of a manufacturing process of PDP 1.

FIG. 5 is a diagram showing an example of a temperature profile of sealing, evacuating, and discharge-gas introducing processes in manufacturing PDP 1.

FIG. 6 is a cross-sectional view of PDP 1A, showing a location at which adsorbent 39 is disposed (an under-the-phosphor-layer type).

FIG. 7 is a flow diagram showing a part of a manufacturing process of PDP 1A (an under-the-phosphor-layer and applied-on-the-barrier-rib-wall type).

FIG. 8 is a cross-sectional view of PDP 1B, showing a location at which adsorbent 39 is disposed (a mixed-in-phosphor type).

FIG. 9 is a flow diagram showing a part of a manufacturing process of PDP 1B (the mixed-in-phosphor type).

FIG. 10 is a graph in which amounts of variations in chromaticity of PDPs are plotted against time after turning-off, for Examples and a Comparative Example.

FIG. 11 is a graph in which an amount of adsorbed water is plotted against temperature, when the adsorbent is allowed to adsorb air after it has undergone an activation treatment.

FIG. 12 is a graph in which an amount of adsorbed carbon dioxide is plotted against temperature, when the adsorbent is allowed to adsorb air after it has undergone the activation treatment.

### DESCRIPTION OF EMBODIMENTS

(Aspects of the Invention)

According to one aspect of the present invention, a PDP includes a front substrate and a rear substrate in such a manner that: The front substrate is such that there are formed: a plurality of display electrode pairs on the surface of the front substrate; a first dielectric layer covering each of the display electrode pairs; and, in addition, a protective layer on the first dielectric layer. The rear substrate is such that there are formed: the plurality of data electrodes on the surface of the rear substrate; a second dielectric layer covering each of the data electrodes; in addition, a plurality of barrier ribs on the second dielectric layer; and phosphor layers directly or indirectly on the side surfaces of the barrier ribs and on the surface of the second dielectric layer. The PDP is configured such that: The front substrate and the rear substrate are disposed via discharge spaces, with one face with the protective layer disposed thereon facing another face with the barrier ribs disposed thereon. The discharge spaces are filled with a discharge gas. In the discharge spaces or in a space permeable to the discharge spaces, a copper-ion-exchanged zeolite adsorbent is disposed, with the adsorbent being in an activated state.

Here, according to another aspect of the present invention, a concentration of CO₂ in the discharge spaces may also be adjusted to be not larger than 1×10⁻² Pa.

Moreover, according to another aspect of the present invention, the adsorbent may also be a zeolite with any one of structure types of ZSM-5, MFI, BETA, and MOR.

In addition, according to another aspect of the present invention, the adsorbent may also be configured to be disposed where at least one of between the phosphor layers and the barrier ribs and between the phosphor layers and the dielectric layer.

Furthermore, according to another aspect of the present invention, the adsorbent may also be configured to be disposed in a laminated state.

Moreover, according to another aspect of the present invention, the adsorbent may also be configured to be disposed and dispersed in the phosphor layers.

In addition, according to another aspect of the present invention, a weight ratio of the adsorbent component to the phosphor component may also be configured to be in the range of not smaller than 0.01 wt % and not larger than 2 wt %.

Furthermore, according to another aspect of the present invention, the adsorbent may also be configured to be disposed on the surface of the protective layer.

Moreover, according to another aspect of the present invention, a coverage factor of the adsorbent to the surface of the protective layer may also be configured to be not larger than 20%.

In addition, according to another aspect of the present invention, the discharge gas may also be configured to contain not smaller than 15% of Xe.

Furthermore, according to another aspect of the present invention, the adsorbent may also be configured to have both physical adsorption characteristics and chemical adsorption characteristics, for at least one of H₂O and CO₂.

Moreover, according to one aspect of the present invention, a method of manufacturing a plasma display panel includes processes of; forming a front substrate; forming a rear substrate; assembling the front substrate and the rear substrate to overlap each other via a sealing material; sealing the assembled front and rear substrates; evacuating a space between the assembled front substrate and the assembled rear substrates; and introducing a discharge gas in discharge spaces located between the front substrate and the rear substrate. In at least one of the process of forming the front substrate and the process of forming the rear substrate, the method further includes a process of disposing a copper-ion-exchanged zeolite adsorbent in the insides of the discharge spaces or in a space having communicative connection with the discharge spaces.

Here, according to another aspect of the present invention, a concentration of CO₂ in the discharge spaces after the process of introducing the discharge gas may also be adjusted to be not larger than 1×10⁻² Pa, through the process of disposing the adsorbent.

Moreover, according to another aspect of the present invention, the adsorbent may also be a zeolite with any one of structure types of ZSM-5, MFI, BETA, and MOR.

Furthermore, according to another aspect of the present invention, the process of forming the rear substrate may also include sub-processes of; forming the plurality of data electrodes and a second dielectric layer covering each of the data electrodes, on the surface of a rear substrate glass; forming a plurality of barrier ribs on the second dielectric layer; and forming phosphor layers directly or indirectly on the side surfaces of the barrier ribs and on the surface of the second dielectric layer. In addition, the sub-processes may also include the process of disposing the adsorbent at a location of at least one of between the phosphor layers and the second dielectric layer and between the phosphor layers and the barrier ribs.

Moreover, according to another aspect of the present invention, the process of forming the rear substrate may also include sub-processes of; forming the plurality of data electrodes and a second dielectric layer covering each of the data electrodes, on the surface of a rear substrate glass; forming a plurality of barrier ribs on the second dielectric layer; and forming phosphor layers directly or indirectly on the side surfaces of the barrier ribs and on the surface of the second dielectric layer. Furthermore, the sub-processes may also include the process of disposing the adsorbent such that the adsorbent is disposed to be dispersed in the phosphor layers.

Additionally, according to another aspect of the present invention, the process of disposing the adsorbent may also be followed by a process of activating the adsorbent to an activated state.

Alternatively, according to another aspect of the present invention, the process of activating the adsorbent may also be carried out in combination with the evacuating process.

Moreover, according to another aspect of the present invention, in the process of activating the adsorbent, the front substrate and the rear substrate may also be heated at temperatures not lower than 400° C. and not higher than a softening point of the sealing material.

Furthermore, according to another aspect of the present invention, in the process of activating the adsorbent, the front substrate and the rear substrate may also be heated in an atmosphere at pressures not larger than 1×10⁻³ Pa.

In addition, according to another aspect of the present invention, in the process of activating the adsorbent, the front substrate and the rear substrate may also be heated for a period of time not smaller than 4 hours.

Furthermore, according to another aspect of the present invention, the process of forming the front substrate may include:

a sub-process including forming a plurality of display electrode pairs on the surface of a front substrate glass, forming a first dielectric layer covering each of the display electrode pairs, and forming a protective layer on the first dielectric layer; and

the process of disposing the adsorbent on the surface of the protective layer.

Moreover, according to another aspect of the present invention, the sealing process may also be carried out in an atmosphere of a nonoxidizing gas, and the evacuating process may also be carried out at a reduced pressure in an atmosphere of a nonoxidizing gas.

In addition, according to another aspect of the present invention, the nonoxidizing gas may also be N₂ gas with a dew point of not higher than −45° C.

Furthermore, according to another aspect of the present invention, in the process of disposing the adsorbent, a coverage factor of the adsorbent to the surface of the protective layer may also be configured to be not larger than 20%.

Moreover, according to another aspect of the present invention, the adsorbent may also be disposed which has both physical adsorption characteristics and chemical adsorption characteristics, for at least one of H₂O and CO₂.

Furthermore, according to another aspect of the present invention, a heating temperature in the evacuating process may also be set to 400° C.

Additionally, according to another aspect of the present invention, in the process of introducing the discharge gas, the discharge gas containing not smaller than 15% of Xe may also be introduced.

Furthermore, according to one aspect of the present invention, a method of evaluating an amount of impurity gases in discharge spaces of a plasma display panel is in such a manner that: The plasma display panel includes:

a front substrate in which there are formed: a plurality of display electrode pairs on the surface of the front substrate; a first dielectric layer covering each of the display electrode pairs; and, in addition, a protective layer on the first dielectric layer; and

a rear substrate in which there are formed: the plurality of data electrodes on the surface of the rear substrate; a second dielectric layer covering each of the data electrodes; in addition, a plurality of barrier ribs on the second dielectric layer; and phosphor layers directly or indirectly on the side surfaces of the barrier ribs and on the surface of the second dielectric layer. The plasma display panel is configured such that: the front substrate and the rear substrate are disposed via discharge spaces, with one face with the protective layer disposed thereon facing another face with the barrier ribs disposed thereon; and the discharge spaces are filled with a discharge gas. The method of evaluating the amount of impurity gases in the discharge spaces includes the steps of; measuring variations in chromaticity when driving the panel for a certain period of time; and evaluating the amount of an increase in the impurity gases in the discharge spaces, based on measured values of the variations in chromaticity.

Moreover, according to another aspect of the present invention, the variations in chromaticity may also be measured by measuring chromaticity of weak light emission of discharge cells when displaying black.

Furthermore, according to another aspect of the present invention, since the plasma display panel is provided with at least green phosphor layers as the phosphor layers, the panel may also be driven for green-color-lighting.

Hereinafter, embodiments of the present invention will be described with reference to the drawings. Needless to say, it should be understood that the present invention is not limited to these embodiments, and that various changes and modifications may be optionally made without departing from the spirit and technological scope of the present invention.

### First Exemplary Embodiment

(Configuration of PDP1)

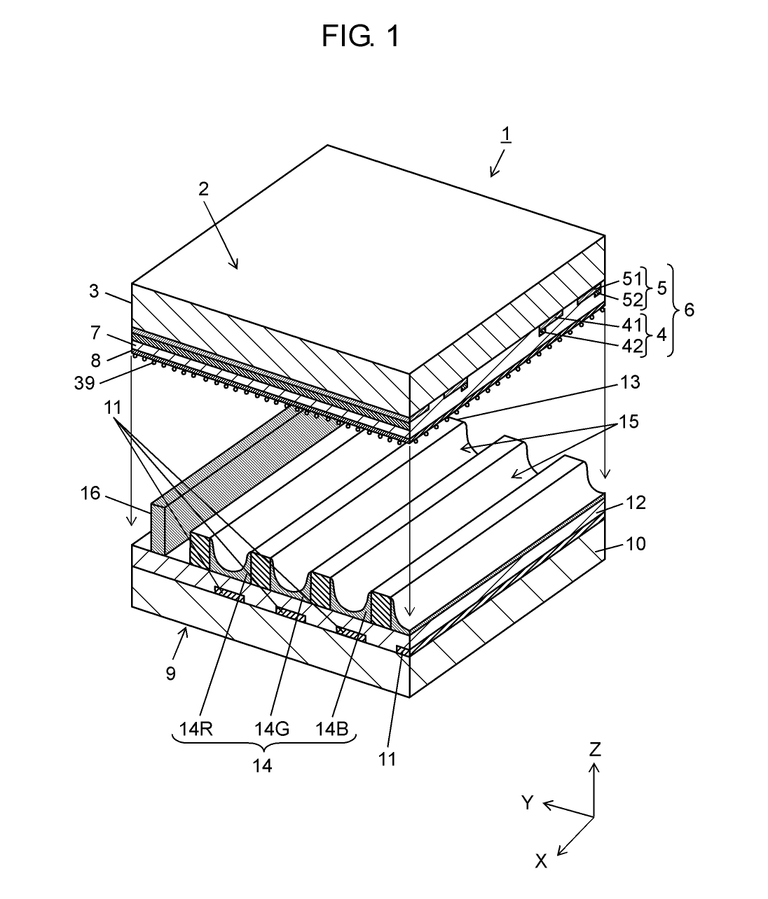

FIG. 1 is a partial perspective view of a configuration of AC-type PDP 1 according to a first embodiment of the present invention. In this Figure, a part is shown of an area including a sealing portion at the peripheral portion of PDP1.

PDP 1 is configured by disposing front substrate (front panel) 2 and rear substrate (back panel) 9, with their inner main surfaces facing each other, and by sealing the peripheries of both substrates 2 and 9 with sealing material 16. Here, PDP 1 is exemplified by the high-definition panel of a 42V-inch full-HD, which has the number of discharge cells equal to 1920×1080 in horizontal and vertical. However, PDP 1 is also applicable to other specifications, for example, a large-screen and ultrahigh-definition panel which is of 100V-inch in panel size and has the number of pixels equal to 7680×4096.

As shown in FIG. 1, PDP 1 is configured mainly with a first substrate (front substrate 2) and a second substrate (rear substrate 9), with their main surfaces being disposed to face each other.

In front substrate glass 3 to be a substrate of front substrate 2, a plurality of display electrode pairs 6 (scan electrode 4 and sustain electrode 5) are formed, in a stripe manner. Each of the display electrode pairs is such that the two electrodes are disposed with a predetermined discharge gap (70 μm), on one of the main surfaces of the front substrate glass.

Scan electrode 4 (sustain electrode 5) in each of display electrode pairs 6 is configured such that bus line 42 (52) is laminated on transparent electrode 41 (51).

Transparent electrodes 41 and 51 are each a strip-shaped transparent electrode (0.1 μm in thickness, 100 μm in width) whose transparent electrically-conductive material is an electrically-conductive metal oxide including indium tin oxide (ITO), zinc oxide (ZnO), and tin dioxide (SnO₂).

Bus lines 42 and 52 are each a strip-shaped metal electrode with a width of approximately 50 μm that is formed using a material including a thick film of Ag (2 μm to 10 μm in thickness), a thin film of Al (0.1 μm to 1 μm in thickness), and a laminated thin film of Cr/Cu/Cr (0.1 μm to 1 μm in thickness). Use of bus lines 42 and 52 reduces the sheet resistance of transparent electrodes 51 and 41.

Note that display electrode pairs 6 may be configured with only a metal material such as Ag, in the same manner as address electrode 11. Transparent electrodes 51, 41, and bus lines 52, 42 can be formed through thin-film forming by sputtering, followed by pattern-etching.

Over the entire main surface of front substrate glass 3 provided with display electrode pairs 6, a first dielectric layer (dielectric layer 7) composed of a low melting-point glass (approximately 30 μm in thickness) is formed by screen printing or the like. The low melting-point glass is chiefly composed of lead oxide (PbO), bismuth oxide (Bi₂O₃), phosphoric oxide (PO₄), or zinc oxide (ZnO).

Dielectric layer 7 has a function of current limiting that is unique to AC-type PDPs, leading to a longer life span than that of DC-type PDPs.

Protective film 8 is a thin film with a thickness of approximately 0.5 μm, and is disposed so as to protect dielectric layer 7 from ion bombardment during discharges and to reduce a discharge starting voltage. The protective film is composed of an MgO material excellent in resistance to sputtering and in secondary electron emission coefficient γ. Moreover, the material exhibits a high optical transparency and electrical insulation properties.

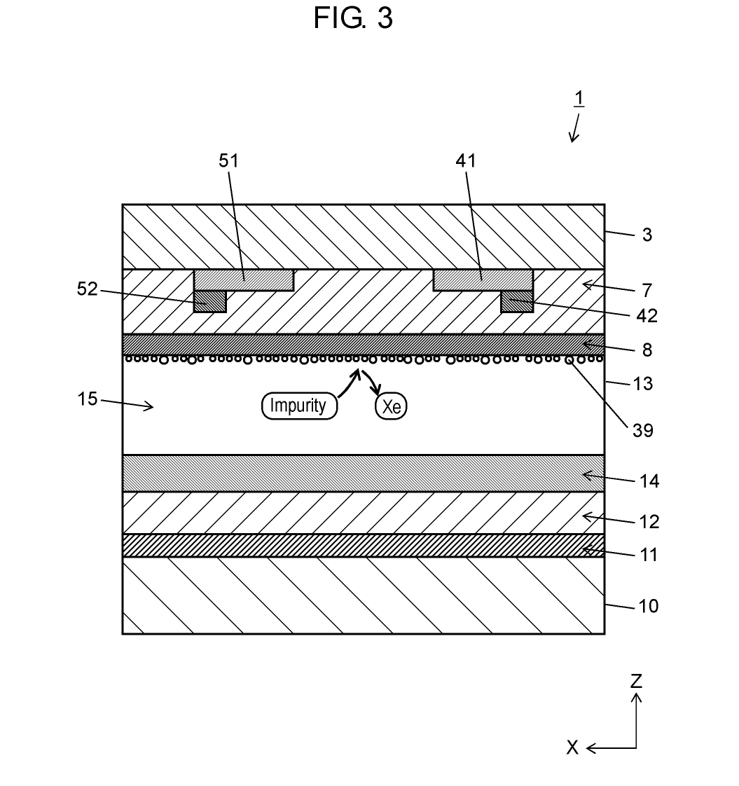

Here, FIG. 3 is a cross-sectional view of PDP 1. As shown in FIG. 3, one of the major features of PDP1 is such that adsorbent 39 in an activated state is disposed in powder form, on the surface of protective film 8. The adsorbent is capable of adsorbing impurity gases (such as CO₂ and H₂O) present in discharge spaces 15, and has the ability to adsorb and desorb Xe. Particles of adsorbent 39 exhibit an average particle diameter of approximately 0.5 μm to 5 μm. The particles are disposed in an amount of the extent to which visible light transparency of front substrate 2 is not decreased.

Adsorbent 39 is preferably configured with a copper-ion-exchanged ZSM-5 type zeolite, for example. The copper-ion-exchanged ZSM-5 type zeolite is preferable for adsorbent 39 because of its characteristics of remarkably adsorbing the impurity gases.

Here, confirmatory experiments conducted by the present inventors have shown that, in a 42-inch full-HD-standard PDP with a configuration using a Ne—Xe system discharge gas (a concentration of Xe: 15%), when the concentration of CO₂, i.e. an impurity gas in the insides of the discharge spaces, increases to be larger than 1×10⁻² during operation, the discharge voltage rises by at least approximately 5.6% to 5.9% from the beginning.

In contrast, in PDP 1, the concentration of CO₂ present in discharge spaces 15 is suppressed to be low concentrations of not larger than 1×10⁻² Pa by disposing such adsorbent 39 described above, thereby preventing an increase in the discharge starting voltage.

In rear substrate glass 10 to be a substrate of rear substrate 9, on one of its main surfaces, address (data) electrodes 11 with a width of 100 μm are disposed in a stripe manner at equal spacings (approximately 95 μm) in the y-direction, assuming that the x-direction is a longitudinal direction. The address electrodes are each configured with any one of a thick film of Ag (2 μm to 10 μm in thickness), a thin film of Al (0.1 μm to 1 μm in thickness), a laminated thin film of Cr/Cu/Cr (0.1 μm to 1 μm in thickness), and the like.

Then, a second dielectric layer (dielectric layer 12) with a thickness of 30 μm is disposed over the entire surface of rear substrate glass 9 so as to include respective address electrodes 11.

Note that, although dielectric layer 12 is the same in configuration as dielectric layer 7, the dielectric layer may also function as a visible-light reflecting layer. In this case, particles with visible-light reflection characteristics, such as TiO2 particles, are mixed to and dispersed in a glass material of the dielectric layer.

Moreover, stripe-shaped barrier ribs 13 (approximately 100 μm in height, 30 μm in width) are disposed on and protrude from dielectric layer 12, by photolithography, with the ribs being aligned with the spaces between adjacent address electrodes 11. With the barrier ribs, the discharge cells are partitioned, thereby preventing occurrence of error discharges and optical crosstalk. The shape of barrier ribs 13 is not limited to the stripe shape, and may be other shapes including a hanging-rack shape and a honeycomb shape.

On the side surfaces of two adjacent barrier ribs 13 and on the surface of dielectric layer 12 located between the ribs, phosphor layers 14 (any of 14(R), 14(G), and 14(B)) are formed with a thickness of 5 μm to 30 μm, respectively corresponding to red color (R), green color (O), and blue color (B) for color display. Dielectric layer 12 is not necessary required; alternatively, address electrodes 11 may be directly included in phosphor layers 14.

Front substrate 2 and rear substrate 9 are disposed facing each other such that the longitudinal directions of address electrodes 11 and display electrode pairs 6 intersect each other at right angles. Then, the outer peripheral portions of both panels 2 and 9 are hermetically sealed with sealing material 16 containing predetermined sealing materials. Then, into discharge spaces 15 secured between both panels 2 and 9, a discharge gas (e.g. a rare gas of 100% of Xe) is introduced which is composed of inert gas components including He, Xe, and Ne, at a predetermined pressure (30 kPa). Here, for improving light-emission characteristics of PDP 1 to achieve high luminance, the discharge gas is preferably one that contains Xe gas at a partial pressure of not smaller than 15%.

Discharge spaces 15 are each a space that exists between adjacent barrier ribs 13. A region, at which one adjacent display electrode pair 6 intersects one address electrode 11 via discharge space 15, corresponds to the respective discharge cells (also referred to as “sub-pixels”) involved in an image display. The pitch of the discharge cells is 150 μm to 160 μm in the x-direction, and 450 μm to 480 μm in the y-direction. Three discharge cells respectively corresponding to adjacent R, G, and B colors configure one pixel (with a square size of from 450 μm to 480 μm, in the x- and y-directions).

Note that, although PDP 1 is exemplified by the configuration in which the number of the discharge cells is equal to 1920×1080 in horizontal and vertical, it is possible to change the size adjustment of the discharge cells. When changing the size, it is necessary to appropriately adjust the followings: the distance (discharge gap) between scan electrode 4 and sustain electrode 5 of respective display electrode pairs 6, the dielectric constant and the thickness of dielectric layers 7 and 12, the height of barrier ribs 13, the pitch of barrier ribs 13, the thickness of phosphor layers 14, and the like. With this configuration, the present invention is also applicable to a large-screen ultrahigh-definition PDP which has a panel size of 100V-inch and the number of discharge cells equal to 7680×4096 in horizontal and vertical.

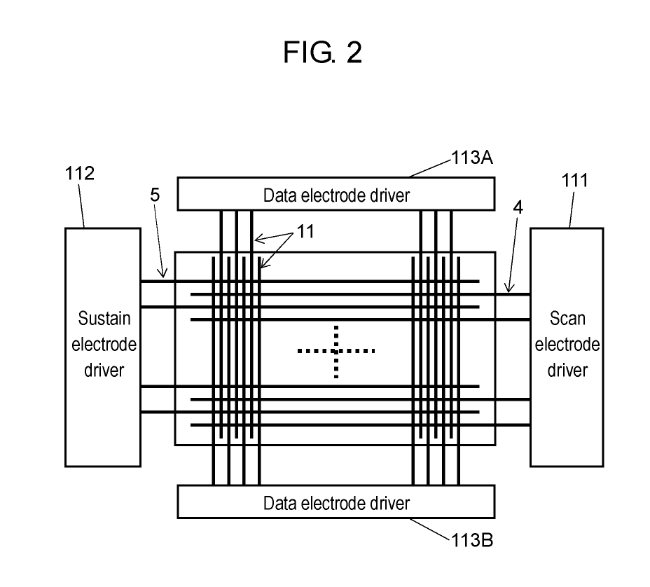

As shown in FIG. 2, scan electrodes 4, sustain electrodes 5, and address electrodes 11 are externally coupled with driver circuits, i.e. scan electrode driver 111, sustain electrode driver 112, address electrode drivers 113A and 113B, respectively.

PDP 1 is coupled with the respective drivers 111, 112, 113A, and 113B described above, thereby allows the PDP to be driven by a known driving method. Description of the driving method of the PDP can be found, for example, in Japanese Patent Application No. 2008-116719.

(Advantages of PDP1)

Thus-configured PDP 1 is such that powdered adsorbent 39 in a high adsorption-active state is disposed to be dispersed on the surface of protective layer 8 facing discharge spaces 15. For this reason, after finishing PDP 1, gases present in discharge spaces 15 are effectively adsorbed and removed. The gases are ones (collectively referred to as “impurity gases”) including: gases derived from phosphor layers 14, and organic constituents of binders, solvents, etc. used in a material (a sealing material paste) of sealing material 16. In particular, the concentration of CO₂ present in discharge spaces 15 is suppressed to be low, i.e. not larger than approximately 10⁻² Pa.

Particularly, in PDP 1, since adsorbent 39 is disposed in the vicinity of protective film 8, the adsorbent can efficiently prevent the impurity gases from being adsorbed by protective film 8. Therefore, this configuration is highly effective in preventing protective film 8 from degradation thereof, which thereby retains good secondary electron emission characteristics of protective film 8, resulting in suppression of increases and variations in the discharge voltage in operation as well as the discharge starting voltage.

Moreover, since the impurity gases are removed from the insides of discharge spaces 15, the impurity gases do not interfere with excitation and ionization of Xe in the discharge gas.

As a result, even when PDP 1 is configured with cells for high-definition and the partial pressure of Xe of the discharge gas is set large, it is possible to reduce power consumption of the PDP and to obtain excellent image display performance.

Note that the copper-ion-exchanged ZSM-5 type zeolite disposed as adsorbent 39 is capable of exhibiting good adsorption characteristics for the impurity gases present in discharge spaces 15, not only after finishing the product of PDP 1, but also during its manufacture processes starting from at least the step of sealing. In this point, particularly, PDP 1 can exhibit excellent advantages.

Note that, in general, when the partial pressure of Xe in the discharge gas of a PDP is increased, its light-emission efficiency increases. However, in the high-definition PDP and the ultrahigh-definition PDP, their light-emission efficiency increases not so much with the increasing partial pressure of Xe, because of occurrence of accumulative ionization of Xe resulting from an increase in their discharge voltage. In contrast, the inventors of the present invention have confirmed the fact that: Application of adsorbent 39 to PDP 1 allows effective removal of the impurity gases from discharge spaces 15 by adsorbent 39, as in the first embodiment, which can keep the discharge gas clean, resulting in a remarkable decrease in the discharge voltage.

Note that, in the first embodiment, although protective film 8 is formed with MgO, the material of protective film 8 is not limited to it but may be any of various alkaline-earth metal oxides. In cases where such protective film 8 is formed, disposing adsorbent 39 to be dispersed on protective film 8 causes the impurity gases to be adsorbed in the same manner as described above, and the same advantages can be expected.

With the above configuration, PDP 1 can achieve high light-emission luminance with low power consumption, leading to an expectation of an increase in the light-emission efficiency by the increased partial pressure of Xe. Moreover, the impurity gases released during the operation of PDP1 are successively adsorbed by adsorbent 39. So that its initial characteristics are held for the long term. As a result, it is possible to extend product life span.

(Development of the Present Invention)

Use of the copper-ion-exchanged ZSM-5 type zeolite as an adsorbent in a PDP is disclosed in Japanese Patent Unexamined Publication No. 2008-218359. It is thought that an applying an adsorbent to PDPs has been generally abandoned. Even if the adsorbent has excellent adsorbability for H2O It is in the case that the adsorbent has adsorbability for Xe.

This results from that the copper-ion-exchanged ZSM-5 type zeolite has been considered to be unusable as an adsorbent for PDPs, because the adsorbent would lose its adsorption activity through adsorption of Xe present in the discharge spaces in a large amount.

However, the present inventors have found the fact that specific adsorbents, such as the copper-ion-exchanged ZSM-5 type zeolite described above, can exhibit high superiority of adsorption for H₂O. That is, even having already adsorbed Xe, the adsorbents has the ability to adsorb H₂O by replacing the already-adsorbed Xe with the H₂O. Moreover, the inventors have found the fact that, in accordance with the mechanism of adsorption, impurity gases such as CO₂ can be adsorbed in the same manner; therefore, the adsorption activity (the ability to adsorb impurity gases besides the discharge gas such as Ne and Xe filled in the discharge spaces) is held, leading to the present invention.

Hereinafter, a method of manufacturing PDP 1 will be exemplified.

(Method of Manufacturing PDP 1)

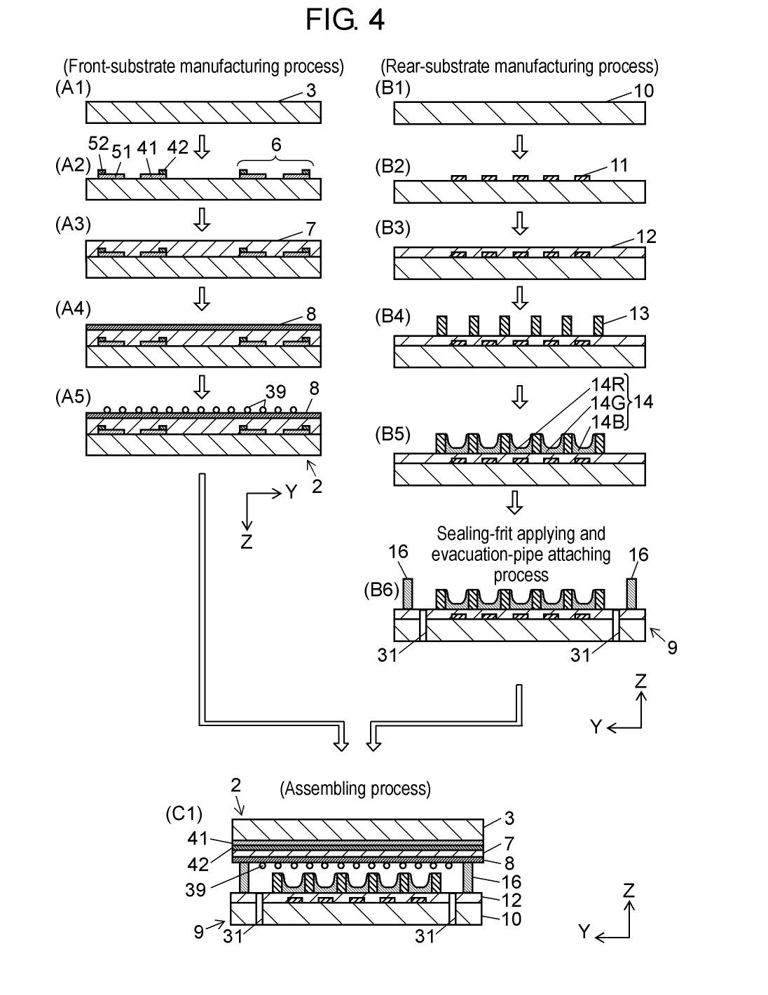

FIG. 4 is a schematic flow diagram showing a part of the manufacturing process of PDP 1.

In the manufacturing process shown in the figure, front substrate 2 is manufactured (sub-processes A1 to A4), as well as rear substrate 9 (sub-processes B1 to B6).

Then, both thus-manufactured substrates 2 and 9 are assembled to overlap each other via a sealing material (assembling process C1). After that, the resulting product sequentially undergoes unshown processes, i.e. sealing, evacuating, and discharge-gas introducing processes. Thus, PDP 1 is completed.

The general flow of the process is almost common to conventional one. A major feature of it is in that predetermined adsorbent 39 is disposed on the surface of protective film 8 in process A5 after having formed protective film 8 in process A4, and that the sealing process and the evacuating process are carried out in a nonoxidizing gas atmosphere.

Hereinafter, a specific description of the respective processes will be made.

(Front-Substrate Manufacturing Process)

Front-substrate manufacturing process includes sub-processes as follows:

Front substrate glass 3 is prepared that is composed of soda-lime glass with a thickness of approximately 1.8 mm (process A1). The method of manufacturing the sheet glass can be exemplified by a known float process.

The manufactured sheet glass is cut into a predetermined size to prepare front substrate glass 3.

Next, on one of the main surfaces of front substrate glass 3, display electrode pairs 6 are formed (process A2).

In this process, transparent electrodes 41 and 51 are formed in a stripe pattern with a finished thickness of 0.1 μm and a finished width of 100 μm on front substrate glass 3, through film formation by sputtering using a transparent electrode material including ITO, SnO₂, and ZnO. Then, bus lines 42 and 52 are formed in a stripe pattern with a thickness of 7 μm and a width of 50 μm on transparent electrodes 41 and 51, through film formation by sputtering using an Ag material.

Other than Ag, the metal material configuring bus lines 42 and 52 may be one including Pt, Au, Al, Ni, Cr, tin dioxide, and indium oxide. Alternatively, a laminated structure of Cr/Cu/Cr may also be used which is formed by repeated film formation.

This completes the formation of display electrode pairs 6.

Next, a paste of a lead-based or non-lead-based glass that exhibits a low melting-point, is applied so as to cover display electrode pairs 6, followed by firing to form dielectric layer 7 (process A3). For the non-lead-based low-melting-point glass, a bismuth-oxide-based low-melting-point glass can be used.

Next, protective film 8 containing MgO is formed on the surface of dielectric layer 7 by vacuum deposition, sputtering, EB-vacuum deposition, etc. (process A4). In use of the EB-vacuum deposition, protective film 8 with a thickness of approximately 1.0 μm is formed through film formation using MgO pellets, with O₂ flowing into the EB-deposition apparatus at 0.1 sccm.

Next, the adsorbent disposing process is such that the copper-ion-exchanged ZSM-5 type zeolite is dispersed as adsorbent 39 on protective film 8 (process A5).

Specifically, powder of adsorbent 39 is mixed to a vehicle such as ethylcellulose to prepare a paste which has a relatively-low powder content of adsorbent 39. The resulting paste is applied on the surface of protective film 8 by printing, spin coating, or the like. Alternatively, instead of preparing the paste, powder of adsorbent 39 may be dispersed in a solvent, and then sprayed on the surface of protective film 8. After dried to a certain level, the resulting product is fired at temperatures of around 500° C. to dispose and spread the powder of adsorbent 39 on the surface of protective film 8.

In this case, Adsorbent 39 is preferably uniformly dispersed on the surface of protective film. The adsorption effect is given to the entire panel.

However, variations may be allowed, to some extent, in the amount of application thereof for every surface region of the panel. For example, the paste may be applied in large quantity in the surface regions corresponding to electrode pairs, in small quantity in the other surface regions.

An excessively-high coverage factor of adsorbent 39 to protective film 8 could be a factor for interfering with discharges during operation and also a factor for reducing visible light transmittance. Accordingly, the coverage factor is preferably not larger than 20%. Moreover, the practical coverage factor is preferably not smaller than 0.1%.

A description of a method of manufacturing the copper-ion-exchanged ZSM-5 type zeolite will be made later.

Thus, front substrate 2 is completed.

(Rear Substrate Manufacturing Process)

Rear-substrate manufacturing process includes sub-processes as follows:

Rear substrate glass 10 is prepared which is composed of soda-lime glass with a thickness of approximately 1.8 mm (process B1). Process B1 is the same as process A1 described above.

Next, an electrically-conductive material chiefly composed of Ag is applied, by screen printing, on one of the main surfaces of rear substrate glass 10 so as to form a stripe pattern with equal spacings (a pitch of approximately 95 μm, in this case). This provides a plurality of address electrodes 11 with a thickness of a few micrometers (e.g. approximately 5 μm) (process B2). The electrode material of address electrodes 11 is one including: a metal such as Ag, Al, Ni, Pt, Cr, Cu, and Pd; an electrically-conductive ceramic including carbides and nitrides of a variety of metals; and various combinations thereof. Address electrodes 11 may also be configured by laminating layers composed of any of these materials.

Subsequently, a paste of lead-based or non-lead-based glass with a low melting-point, is applied on the entire surface of rear substrate glass 10 provided with address electrodes 11, followed by firing to form dielectric layer 12 (process B3).

Next, a plurality of barrier ribs 13 are formed in a stripe pattern on the surface of dielectric layer 12 (process B4). A phosphor ink is applied on the wall surfaces of barrier ribs 13 and on the surface of dielectric layer 12 exposed between adjacent barrier ribs 13, with the ink containing any one of phosphors of red color (R), green color (O), and blue color (B) which are commonly used in AC-type PDPs. The applied ink is dried and fired to form respective phosphor layers 14 (14R, 14G, and 14B) (process B5).

Here, the chemical composition of each of the R, G, and B phosphors is exemplified by the followings, for example; however, it is not limited to them, as a matter of course.

Red phosphor: (Y, Gd)BO₃:Eu,

Green phosphor: Zn₂SiO₄:Mn, or a mixture of it and YBO₃:Tb,

Blue phosphor: (Ba, Sr)MgAl₁₀O₁₇:Eu.

(Sealing-Material Applying Process and Sealing-Material Calcinating Process)

Next, in the following steps, a paste containing sealing frit (powder of a sealing material) is applied to the outer periphery of rear substrate 9, and then calcinated. Moreover, an unshown tip-pipe (an exhaust pipe) is attached to tip-pipe attaching hole 31 disposed in rear substrate 9 such that the tip-pipe is communicatively connected with discharge spaces 15 (sealing-frit applying and exhaust-pipe attaching process B6).

First, a sealing-material paste is prepared by mixing a resin binder and a solvent to form a predetermined sealing material. The softening point of the sealing material is preferably in the range from 410° C. to 450° C.

In the calcinating process, firstly, the temperature of a firing furnace is increased from room temperature to calcination temperature. The calcination temperature is the highest temperature in the calcinating process, and is set to temperatures higher than the softening point of the low-melting-point glass of the sealing material. In this case, the highest temperature of calcination is kept for a certain period of time (e.g. 10 minutes to 30 minutes) to carry out the calcination. After that, the temperature of rear substrate 9 is allowed to decrease to room temperature.

Through the calcination in this manner, a large part of organic constituents in the sealing material paste are removed, and hardness of sealing material 16 is secured to some extent.

Note that, in general, the calcinating process causes the solvents and the binder constituents in the sealing material paste to burn into carbon dioxide (CO₂), and removes the carbon dioxide. In the presence of large amounts of oxidizing gases, e.g. oxygen, in the atmosphere, the carbon dioxide is rapidly generated to form bubbles of glass constituents of the sealing material, which possibly results in incomplete sealing. If the sealing is incomplete, it can later cause a leakage of the discharge gas. Therefore, to prevent the formation of bubbles of the glass constituents, the calcination is preferably carried out under a weak-oxidizing gas atmosphere where the oxidizing gas constituents are reduced (e.g. an atmosphere containing nitrogen with an oxygen partial pressure of not larger than 1%), or under a nonoxidizing gas atmosphere (an atmosphere containing nitrogen).

Note that, in the first embodiment, the temperature of calcinating sealing material 16 is exemplified by the case where the calcination temperature is set at temperatures not lower than the softening point of sealing material 16; however, the temperature is not limited to them. For example, if the calcination is carried out at temperatures not lower than the softening point of sealing material 16, residues of the binder constituents in sealing material 16 are sometimes trapped by the softened low-melting-point glass contained in sealing material 16, which can cause the trapped binder constituents to turn into tar constituents that are hard to volatilize. In the subsequent sealing process, since the sealing is carried out at a flow temperature of sealing material 16, the trapped tar constituents are released due to dissolution of sealing material 16 and, in turn, adhere to the phosphors, the MgO, and adsorbent 39. This sometimes interferes with secondary electron emission of the MgO, leading to an increase in the discharge voltage, and a decrease in luminance of the phosphors and in adsorption performance of adsorbent 39. In this case, to prevent the formation of the tar constituents, the calcination temperature is preferably set to temperatures lower than the softening point of the sealing material.

On the other hand, even if the tar constituents are formed, the calcination temperature may be set to temperatures not lower than the softening point in the case where adsorbability of adsorbent 39 can be held sufficiently high, and contamination of the phosphors and the MgO can be suppressed to a negligible level.

In this way, the calcination temperature is preferably adjusted depending on the kinds of the sealing material and adsorbent 39. For example, when using a low-melting-point glass material chiefly composed of lead-oxide-based glass, it is preferable to set the calcination temperature at temperatures 10° C. to 20° C. lower than the softening point of the sealing material, in preventing the formation of tar constituents. In adjusting the temperature, it is recommended to refer to the glass transition point of the sealing material, in addition to the softening point thereof.

(Assembling Process)

Thus-manufactured front substrate 2 and rear substrate 9 are assembled to overlap and face each other such that display electrode pairs 6 intersect address electrodes 11 at right angles (process C1). In this case, to prevent misalignment of substrates 2 and 9, both the substrates are held by clipping them with clips (not shown) with spring mechanism. In aligning, the alignment is made in such a manner that, in each of the discharge cells, the center point in the x-direction between barrier ribs 13 is aligned with the center point between scan electrode 4 and sustain electrode 5.

(Sealing Process)

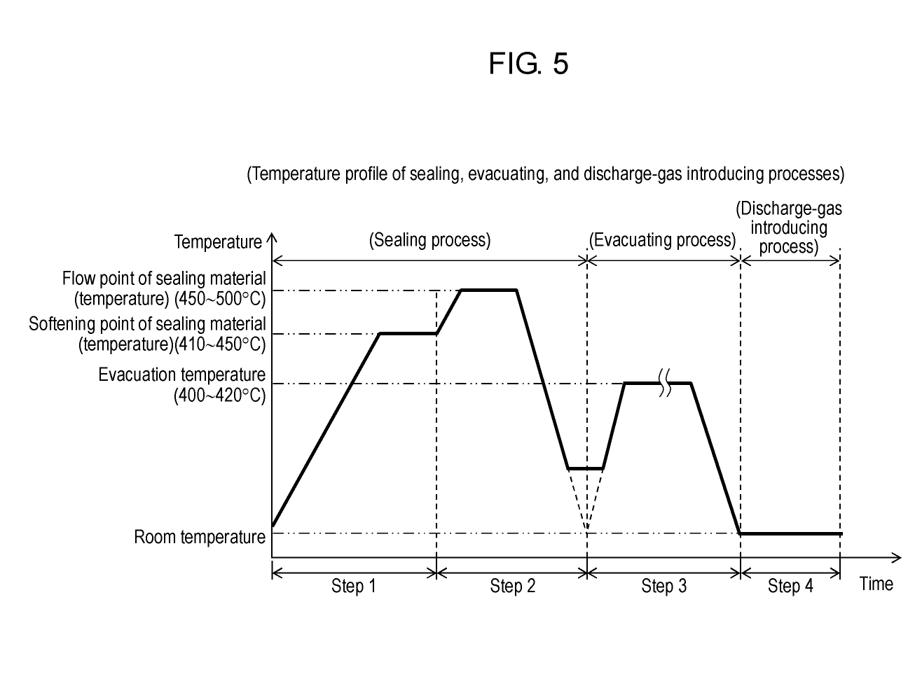

FIG. 5 shows a temperature profile of sealing process, evacuating process, and discharge-gas introducing process.

The sealing process is carried out in a nonoxidizing gas atmosphere, which includes: increasing the temperature from room temperature to sealing temperature of not lower than the flow temperature of sealing material 16; holding the thus-increased temperature for a certain period of time; and then decreasing the temperature to temperatures lower than the softening point of sealing material 16. The nonoxidizing gas is preferably N₂ or Ar.

Specifically, aligned substrates 2 and 9 are first placed in a vacuum furnace, and then the whole furnace is evacuated to pressures not larger than 10 Pa with a vacuum pump. The evacuation of oxidizing gases can prevent protective film 8 from being oxidized and degraded by gas constituents. After the evacuation, a nonoxidizing gas (Ar or N₂) with a dew point of not higher than −45° C. is introduced into the whole furnace. In this case, concentration of residual oxygen is preferably not larger than 100 ppm. Note that, although residual water vapors act as an oxidizing gas which causes protective film 8 to deteriorate, the introduction of the nonoxidizing gas with a dew point of not higher than −45° C. can reduce the amount of the residual water vapors. Subsequently, the temperature is increased from room temperature up to temperatures (approximately 410° C. to 450° C.) around the softening point of sealing material 16, and is then held for one hour (this completes step 1).

Next, the temperature of the furnace is increased from the temperature around the softening point of sealing material 16 up to the sealing temperature (approximately 450° C. to 500° C., e.g. approximately 490° C.) not lower than the flow temperature of sealing material 16, and is then held for one hour. The temperature-rise rate is adjusted so as to prevent the panel from cracking due to a temperature distribution in the furnace resulting from a rapid temperature rise. This heat treatment causes sealing material 16 to soften, so that front substrate 2 and rear substrate 9 are sealed. After that, thus-sealed substrates 2 and 9 are cooled down to around room temperature, and are taken out from the vacuum furnace (this completes step 2).

Note that, in the first embodiment, the description has been made regarding the case where the sealing process is carried out in the N₂ atmosphere with a dew point of not higher than −45° C.; however, other inert-gas atmospheres may be used. Particularly, Ar is preferable because it is less active than N₂ and relatively inexpensive. Moreover, there are cases where contamination, if in a very small amount, of oxygen (or air) into the inert gas is not a problem.

(Evacuating Process)

Next, sealed substrates 2 and 9 are placed in an evacuation furnace and are coupled with a turbo-molecular pump via the tip-pipe, and then discharge spaces 15 thereof is evacuated to vacuum. The vacuum pressure is preferably not larger than 1×10⁻³ Pa. Since nonoxidizing gases have been stored in the insides of discharge spaces 15 of both substrates 2 and 9 sealed in the preceding process, then the evacuating process is carried out in the nonoxidizing gas atmosphere at a reduced pressure in the insides of discharge spaces 15.

After completing the evacuation, with the reduced pressure being held, the temperature of the whole furnace is increased up to temperatures of 400° C. to 420° C. lower than the softening point of sealing material 16, and is held for 4 hours (heating process). With this increased temperature, impurity gases are evacuated from the insides of discharge spaces 15 of sealed substrates 2 and 9, and simultaneously the gases having already been adsorbed by adsorbent 39 are also released therefrom. The temperature is preferably adjusted in such a manner that the temperature is held for a certain period of time at a temperature 10° C. lower than the softening point of sealing material 16, and is then decreased to room temperature. However, the required temperature must be not lower than the temperature at which adsorbent 39 is activated and not lower than the glass transition point of the low-melting-point glass configuring sealing material 16.

After that, adsorbent 39 is held in an activated state after having undergone the cooling process to cool down to around room temperature (this completes step 3).

Note that adsorbent 39 applied on protective film 8 in process A5 described above, is decreased in its adsorption activity for impurity gases due to its adsorption of gases such as nitrogen, oxygen, and water vapors during the firing in air after the application thereof. However, adsorbent 39 can achieve the adsorption activity through the heating that is carried out in the nonoxidizing gas atmosphere in the processes of sealing to evacuating, as described above.

Therefore, through undergoing such the evacuating process, adsorbent 39 is disposed to face discharge spaces 15 with the adsorbent remaining its good adsorption activity. Accordingly, a variety of impurity gases released in the subsequent processes can be adsorbed and removed efficiently from discharge spaces 15.

(Discharge-Gas Introducing Process)

After cooling, the discharge gas is introduced into discharge spaces 15 between sealed substrates 2 and 9 via the tip-pipe.

In the first embodiment, the discharge gas is 100% Xe gas (Xe gas with a purity not smaller than 99.995%) and the sealed-gas pressure is 30 kPa. However, other gases including a Ne—Xe based mixed gas and a Ne—Xe—Ar based mixed gas may also be used. Moreover, the sealed-gas pressure is preferably appropriately adjusted depending on a mixing ratio of Xe. When the mixing ratio of Xe is small, the sealed-gas pressure is preferably set to be higher, for example, to 60 kPa. The basic method of manufacturing the configurations of the modifications of PDP 1 is the same as that of PDP 1 described above.

Note that, since adsorbent is capable of adsorbing and desorbing Xe gas, adsorbent disposed on protective film can adsorb a slight amount of Xe gas in the discharge-gas introducing process.

(Aging Process)

Thus-manufactured PDP 1 is subjected to an aging process. The aging is carried out by driving PDP 1 and lasts until the discharge voltage of each cell becomes uniformly stable.

In the aging process, because PDP 1 is energized for the first time, impurity gases relatively tend to be released from the phosphor layers. The impurity gases, however, are rapidly adsorbed and removed from discharge spaces 15 by adsorbent 39 with good adsorption activity for the impurity gases, with the adsorbent being disposed to face discharge spaces 15.

Note that, since adsorbent is in the state that adsorbing Xe, adsorbent 39 releases Xe and adsorb the impurity gases, as shown in FIG. 3.

Thus, the above processes complete PDP 1.

(Method of Preparing Copper-Ion-Exchanged ZSM-5 Type Zeolite)

The copper-ion-exchanged ZSM-5 type zeolite, serving as adsorbent 39, can be prepared by the method exemplified as follows. Note that the method is common to adsorbents 39 used in the respective embodiments.

Specifically, the preparation is carried out through sequential processes including: ion-exchanging using an ion-exchange solution containing copper ions and ions exhibiting a buffer action (step 1); cleaning the copper-ion-exchanged ZSM-5 type zeolite (step 2); and drying the zeolite (step 3).

In the ion-exchange process (step 1), the solution containing copper ions may be an aqueous solution of a conventional compound including copper acetate, copper propionate, and copper chloride. Among others, copper acetate is preferable to achieve an increased capacity of gas-adsorption and strong adsorption thereof.

As ions having a buffer action in the ion-exchange solution, ions such as acetate ions and propionate ions, for example, are usable which have an action of buffering the ionic dissociation equilibrium of the solution containing copper ions. Of these ions, acetate ions are preferable to achieve large-capacity adsorption characteristics in a low-pressure region. In particular, acetate ions derived from ammonium acetate are preferable.

The ion-exchange solution containing copper ions and ions having the buffer action may be prepared by mixing separate solutions which have been separately prepared to contain the respective ions. Alternatively, it may also be prepared by dissolving the respective solutes into a solvent.

The thus-prepared ion-exchange solution is added and mixed with a zeolite material, thereby performing the ion-exchange treatment. Note that, in this case, the following factors are not particularly limited, including: the number of ion-exchanges, the concentration of the copper ion solution, the concentration of the buffer solution, the time period for the ion-exchange, and the temperature. However, when the ion exchange factor is set to be in a range of 100% to 180%, excellent adsorption performance can be achieved. More preferable ion exchange factor is in a range of 110% to 170%.

Note that the “ion exchange factor” referred to here is a calculated value obtained on the basis that one Cu²⁺ is exchanged for every two Nat Practically, there is a possibility that copper is exchanged as Cu⁺: therefore, the calculated values of “ion exchange factor” described above exceed 100%.

Next, proceeding to the cleaning process (step 2), the material having undergone the ion-exchange treatment described above is then cleaned. In this process, the cleaning is preferably carried out using such as distilled water for preventing contamination of impurity ions.

After cleaning sufficiently, the material is dried in the drying process (step 3). In this case, to prevent degradation caused by high temperatures, drying is preferably carried out in a gentle condition at temperatures lower than 100° C. Moreover, drying at room temperature in a reduced-pressure atmosphere is also preferable.

Through the respective steps described above, the copper-ion-exchanged ZSM-5 type zeolite is obtained.

### First Performance-Measurement Experiment for First Exemplary Embodiment

Based on the method of manufacturing PDP1, the following PDPs of Example 1 and Comparative Examples 1 to 3 were manufactured, and subjected to a performance-measurement experiment. All PDPs included 100% Xe gas as discharge gas.

### Example 1

In the front-substrate manufacturing process, the adsorbent was disposed by printing.

Specifically, approximately 0.5 to 2 parts by weight of powder of adsorbent 39 were mixed with 100 parts by weight of an ethylcellulose-based vehicle. The resulting product was subjected to three-roll mill treatment to form a paste. Then, the paste was applied thinly on protective film 8 (MgO layer) by printing. The applied paste was dried at a temperature of 90° C., and then fired in air at a temperature of 500° C. In this case, the coverage factor is ratio of the fired protective film 8 which has been covered by the powder of adsorbent 39 was set to 6% by adjusting the concentration of the paste.

Note that the coverage factor of adsorbent 39 was calculated by the following equation.

Coverage factor=(1−τp2/τp1)×100,

where τp1 is the linear transmission factor of the substrate without application of adsorbent 39, and τp2 is the linear transmission factor of the substrate with application of adsorbent 39.

The sealing process was carried out in an N₂ atmosphere of a dew point of not higher than −45° C.

### Comparative Example 1

For Comparative Example 1, a PDP was manufactured without using adsorbent 39, and the sealing process was carried out in the N₂ atmosphere in the same manner as for Example 1.

### Comparative Example 2

For Comparative Example 2, a PDP was manufactured without using adsorbent 39, and the sealing process was carried out in air.

### Comparative Example 3

For the Comparative Example, the sealing process was carried out in air. Except for this, a PDP was manufactured by using adsorbent 39 in the same manner as for Example 1.

Note that the way to dispose adsorbent 39 and the way to evaluate the coverage factor are the same as those for Example 1.

### Reference Example 1

For Reference Example 1, the coverage factor of protective film 8 by adsorbent 39 was adjusted to be 21%. Except for this, a PDP was manufactured in the same manner as for Example 1.

(Measurement and Evaluation)

Each of the thus-manufactured PDPs were subjected to a measurement of the discharge sustaining voltage.

Table 1 shows the measurement results.

TABLE 1

| | | adsorbent | discharge |
|---|---|---|---|
| | | coverage | sustaining |
| | sealing gas | factor/% | voltage/V |
| Example 1 | N₂ | 6 | 217 |
| Comparative Example 1 | N₂ | 0 | 225 |
| Comparative Example 2 | air | 0 | 259 |
| Comparative Example 3 | air | 6 | >330 |
| Reference Example 1 | N₂ | 21 | 235 |

From the results shown in Table 1, it can be considered as follows.

Comparing Example 1 with Comparative Example 1, although both PDPs were sealed in N₂ gas, the PDP of Example 1 with adsorbent 39 disposed on the protective film shows a lower discharge sustaining voltage than that of the PDP of Comparative Example 1 without adsorbent 39. This shows that adsorbent 39 has adsorbed impurity gases present in discharge spaces 15, resulting in a suppression of degradation of protective film 8. This also shows that approximately 6% of the coverage factor of adsorbent 39 is enough to achieve the sufficient advantage.

On the other hand, the PDPs of Comparative Examples 2 and 3 sealed in air show higher discharge sustaining voltages than that of the PDP of Example 1. This shows that the degradation of protective film 8 has occurred in Comparative Examples 2 and 3.

In addition, the discharge sustaining voltage is higher in Comparative Example 3 than in Comparative Example 2. This reason can be considered as follows: if adsorbent 39 has adsorbed a large amount of such as water, carbon dioxide, and oxygen contained in air during heating in air, a part of the adsorbent becomes in a state that the part is no longer capable of exhibiting its adsorption characteristics even if heated in vacuum in the evacuating process. Because of the thus-reduced adsorption characteristics, a discharge inhibiting action caused by the disposition of adsorbent 39 on protective film 8 becomes adversely predominant over the adsorption effect of the adsorbent.

Note that it is predictable that the presence of adsorbent 39 on protective film 8 could be a physical discharge-inhibiting factor to some extent, even if the sealing process is carried out in the N₂ gas atmosphere as in Example 1. Regardless of the prediction, however, the effect of reducing the discharge sustaining voltage is obtained, which is considered to be attributed to the following two points:

The first is that: When adsorbent 39 is heated in the N₂ gas atmosphere in the sealing process, the adsorbent can very well adsorb impurity gases released in the aging process and subsequent ones because the adsorbent can be activated in the subsequent evacuating process. Therefore, it is thought that thus-activated adsorbent can reduce the amount of the impurity gases present in discharge spaces 15, which relatively prevents degradation in secondary electron emission characteristics of protective film 8.

The second is that: Since adsorbent 39 is capable of adsorbing and desorbing Xe gas, it is thought that adsorbent 39 desorbs the adsorbed Xe gas upon adsorbing the impurity gases, which thereby increases excitation and ionization probabilities of Xe in the vicinity of protective film 8.

It is thought that the effect of reducing the discharge voltage by these actions is predominant over the discharge inhibiting action of adsorbent 39 on protective film 8, resulting in the decrease in the discharge voltage.

In Reference Example 1 where the coverage factor by adsorbent 39 exceeds 20%, the discharge sustaining voltage is lower than those in Comparative Examples 2 and 3, but higher than that in Comparative Example 1 where adsorbent 39 is not disposed. This shows the fact that, when the coverage factor by adsorbent 39 exceeds 20%, although there exists the action of adsorbent 39 to sustain the discharge voltage through the adsorption of impurity gases, the action of adsorbent 39 to interfere with the discharge becomes adversely large.

### Second Performance-Measurement Experiment for First Exemplary Embodiment

Next, based on the method of manufacturing PDP1, the following PDPs of Example 2 and Comparative Examples 4 to 6 were manufactured, and subjected to a performance-measurement experiment. Here, a Ne—Xe based mixed gas was used as the discharge gas.

### Example 2

A PDP of Example 2 was manufactured in the same manner as for Example 1 except that the discharge gas was a Ne—Xe based mixed gas (with a Xe mixing ratio of 20%) and the discharge gas introduction was carried out at a pressure of 60 kPa. However, the coverage factor of protective film 8 by adsorbent 39 was set to 12%.

### Comparative Example 4

For Comparative Example 4, a PDP was manufactured in such a manner that adsorbent 39 was not used and the sealing process was carried out in an N₂ atmosphere in the same manner as for Example 2. The discharge gas was the same as that in Example 2.

### Comparative Example 5

For Comparative Example 5, a PDP was manufactured in such a manner that adsorbent 39 was not used and the sealing process was carried out in air. The Xe mixing ratio was set to 10%.

### Comparative Example 6

For Comparative Example 6, a PDP with adsorbent 39 was manufactured in the same manner as for Example 2 except that the sealing process was carried out in air. However, the Xe mixing ratio was set to 10%.

(Measurement and Evaluation)

Each of the thus-manufactured PDPs was subjected to a measurement of the discharge sustaining voltage.

Table 2 shows the measurement results.

TABLE 2

| | | adsorbent | discharge |
|---|---|---|---|
| | | coverage | sustaining |
| | sealing gas | factor/% | voltage/V |
| Example 2 | N₂ | 12 | 187 |
| Comparative Example 4 | N₂ | 0 | 194 |
| Comparative Example 5 | air | 0 | 182 |
| Comparative Example 6 | air | 6 | 193 |

From the results shown in Table 2, it can be considered as follows.

The PDP of Example 2 shows a lower discharge sustaining voltage than that of Comparative Example 4. This shows that adsorbent 39 has adsorbed impurity gases present in discharge spaces 15, resulting in a suppression of degradation of the protective film.

It has been confirmed that, in the case where the Ne—Xe based mixed gas instead of the 100% Xe gas is used as the discharge gas, the same effect of reducing the discharge sustaining voltage is achieved as that in the case using the 100% Xe gas.

Comparing Comparative Example 5 with Comparative Example 6 in which both PDPs used the discharge gas with a Xe mixing ratio of 10% and were sealed in air, Comparative Example 6 with adsorbent 39 shows a higher discharge sustaining voltage than that of Comparative Example 5 without adsorbent 39. The reason of this can be considered as follows: Having adsorbed a large amount of water, carbon dioxide, oxygen, etc. contained in air during heating in air, adsorbent 39 can inhibit the discharge.

Note that Example 2 shows the lower discharge sustaining voltage than that of Example 1 described above. This is attributed to the Xe mixing ratio of 20% in Example 2 that is lower than 100% in Example 1.

Moreover, regardless of the heating carried out in air, Comparative Example 5 shows the lower discharge sustaining voltage than that of Example 2. This is attributed to the Xe mixing ratio of 10% in Comparative Example 5 that is lower than 20% in Example 2.

Hereinafter, other embodiments of the present invention will be described, focusing on differences from the first exemplary embodiment.

### Second Exemplary Embodiment

(Configuration of PDP1A)

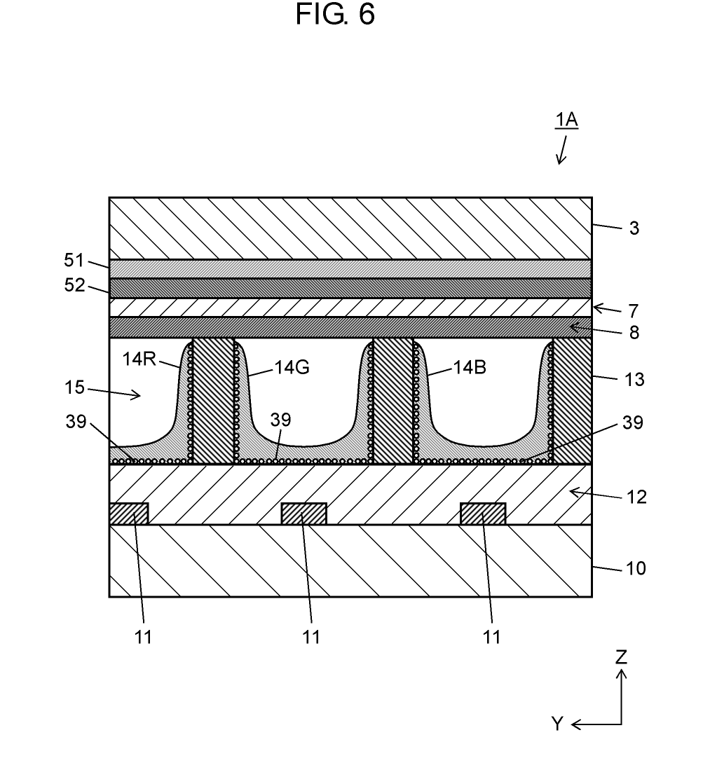

FIG. 6 is a cross-sectional view of PDP 1A (an under-the-phosphor-layer and applied-on-the-barrier-rib-wall type) according to a second embodiment. PDP 2 basically has the same configuration as that of PDP1 except for differences in that a reduction of discharge voltage is achieved in such a manner as follows. Adsorbent 39 is disposed, in a layer form, between adjacent barrier ribs 13 and phosphor layers 14 (14R, 14G, and 14B) or between dielectric layer 12 and phosphor layers 14 (14R, 14G, and 14B), with the adsorbent being composed of powder of the copper-ion-exchanged ZSM-5 type zeolite in an activated sate. As a result, the concentration of CO₂ present in discharge spaces 15 is suppressed to low concentrations of not larger than 1×10⁻² Pa.

PDP 1A having such the configuration, is expected having similar advantages as PDP 1.

That is, phosphor layers 14 contain a number of small voids which are substantially communicatively connected with discharge space 15. Therefore, impurity gases or the like are efficiently adsorbed and removed by adsorbent 39 via phosphor layers 14, with the gases being released in discharge space 15 associated with driving.

Moreover, differed from PDP 1, PDP 1A is confirmed to be capable of achieving a good adsorption-active state of adsorbent 39 even if the disposing process (process B4′ described below) of adsorbent 39 is carried out in air. In this viewpoint, there exists a large advantage in manufacturing process of the PDP. Furthermore, adsorbent 39 (copper-ion-exchanged ZSM-5 type zeolite) obtained by the manufacturing process can exhibit excellent chemical adsorption characteristics because copper, a constituent of the adsorbent, is reduced to be univalent (Cu¹⁺) that has high chemical adsorption activity. With this configuration, adsorbent 39 is capable of synergistically exhibiting the chemical adsorption characteristics, in addition to physical adsorption characteristics that are primarily characterized.

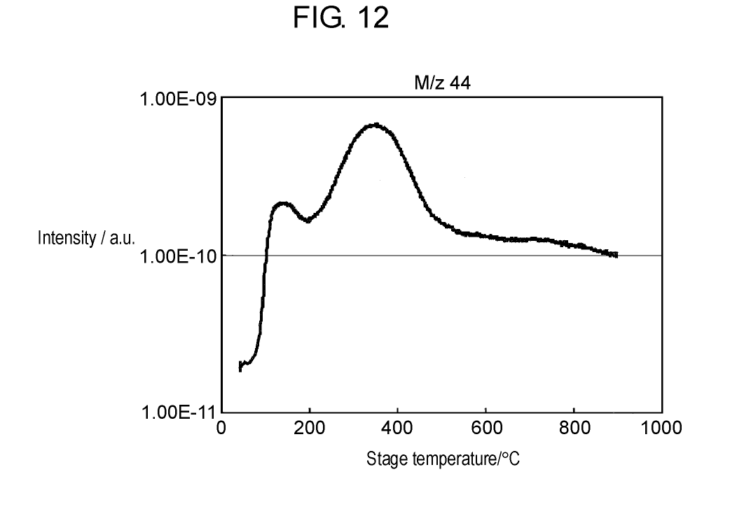

Note that, in the present invention, the activated state of adsorbent 39 is a state in which the adsorbent has the characteristics capable of adsorbing CO₂ gas. Here, the “activated state” is defined in terms of not only the above-described change in valency of copper in adsorbent 39, but also the presence of peaks in the graphs of FIGS. 11 and 12 that show measurement results with a thermal desorption spectrometer, as described later.

(Method of Manufacturing PDP 1A)

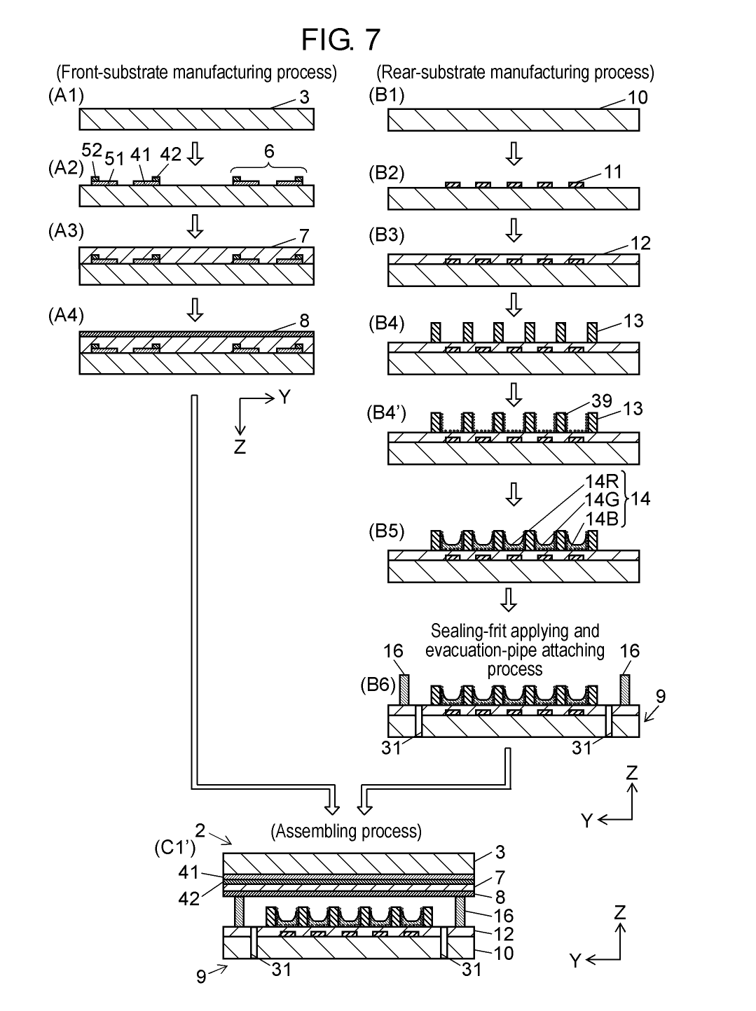

FIG. 7 shows a part of a manufacturing process of PDP 1A. Differences from the manufacturing process of PDP1 are as follows: In sub-processes of the front-substrate manufacturing process, process A5 is omitted. Moreover, in sub-processes of the rear-substrate manufacturing process, adsorbent disposing process B4 is added between process B4 and process B5, in which adsorbent 39 is disposed by applying a paste containing adsorbent 39 on the surfaces of adjacent barrier ribs 13 and on the surface of dielectric layer 12 located between the ribs.

Hereinafter, adsorbent disposing process B4 will be specifically described.

First, powder of adsorbent 39 is mixed to a vehicle such as ethylcellulose to prepare a paste, in the same manner as the preparation method in process A6 in the first embodiment. The paste is applied on the surfaces of adjacent barrier ribs 13 and on the surface of dielectric layer 12 located between the ribs, by printing or the like. After the applied paste is dried to a certain level, the dried paste is fired at temperatures of around 500° C. in air, for example, to dispose and spread the powder of adsorbent 39.

Note that, in process B4′, a dispersion liquid containing adsorbent 39 may be applied by spraying, and the above-described firing of the paste may be carried out in combination with the firing of phosphors in process B5. In this case, when adsorbent 39 is disposed uniformly over the surface to be applied, a uniform adsorption effect can be expected to cover a wide area which is communicatively connected with discharge spaces 15. However, the adsorbent may be locally applied, for example, only on the surface of dielectric layer 12, or only on the surfaces of barrier ribs 13 (or, moreover, only on the surface of dielectric layer 12 and the surfaces barrier ribs 13, with these surfaces corresponding to one-color or two-colors of phosphor layers 14). After that, phosphor layer forming process B5 described above, and sealing-frit applying and evacuation-pipe attaching process B6 are sequentially carried out.

Subsequently, front substrate 2 and rear substrate 9 are assembled to overlap and face each other such that display electrode pairs 6 intersect address electrodes 11 at right angles (process C1′).

After that, the sealing process and the evacuating process may be sequentially carried out in the same manner as in the first embodiment. In this case, in the same manner as the manufacturing processes of PDP1, the sealing process may be carried out in a nonoxidizing gas atmosphere and the evacuating process may be carried out in a predetermined inert gas atmosphere or in vacuum, which allows the evacuating process to be carried out in combination with the adsorbent activating process. This results in high adsorption activity of adsorbent 39. In this way, the combination of the evacuating process with the adsorbent activating process preferably allows the streamlining of the processes. Hereinafter, a description is made of an example of specific settings in the case where the evacuating process is carried out in combination with the adsorbent activating process. The heating (firing) process is carried out in an atmosphere of low pressures, i.e. lower than atmospheric pressure, more preferably lower than 1×10⁻³ Pa. The heating temperature in this case is preferably in a temperature range of not lower than 400° C. and not higher than the softening point of sealing material 16. Moreover, the period of time for the heating is preferably not smaller than 4 hours.

Note that, although the adsorbent activating process is carried out in combination with the evacuating process, it may also be carried out at any timing after adsorbent disposing process B4′. For example, it is also possible to additionally carry out the adsorbent activating process after the evacuating process, in the conditions of the heating (firing) process described above.

Moreover, to prevent re-degradation in adsorption activity of adsorbent 39 for impurity gases, the adsorbent should be carefully handled not to be exposed to the atmosphere (oxidizing gases) after having undergone the adsorbent activating process.

Note that, the above description regarding the adsorbent activating process is commonly held in the manufacturing process of PDP B1 to be described later.

The adsorbent activating process is sequentially followed by the discharge-gas introducing process and the aging process, in the same manner as the manufacturing process of PDP 1. This completes PDP 1A.

Note that the atmosphere of the sealing process in the manufacturing process of PDP 1A is not limited to the nonoxidizing atmosphere and the inert atmosphere described above. The reason of this is as follows: In PDP 1A, it is possible to dispose adsorbent 39 at a place away from the surface of protective film 8, such as the surfaces of adjacent barrier ribs 13 and the surface of dielectric layer 12 between the ribs. The place is communicatively connected with discharge spaces 15 and involves no action of interfering with discharges. Accordingly, the good effects can be achieved of the adsorption and the removal of the impurity gases present in discharge spaces 15, even if the adsorption characteristics of adsorbent 39 is degraded to some extent due to the adsorption of the impurity gases released in the sealing process.

### Third Exemplary Embodiment

(Configuration of PDP1B)

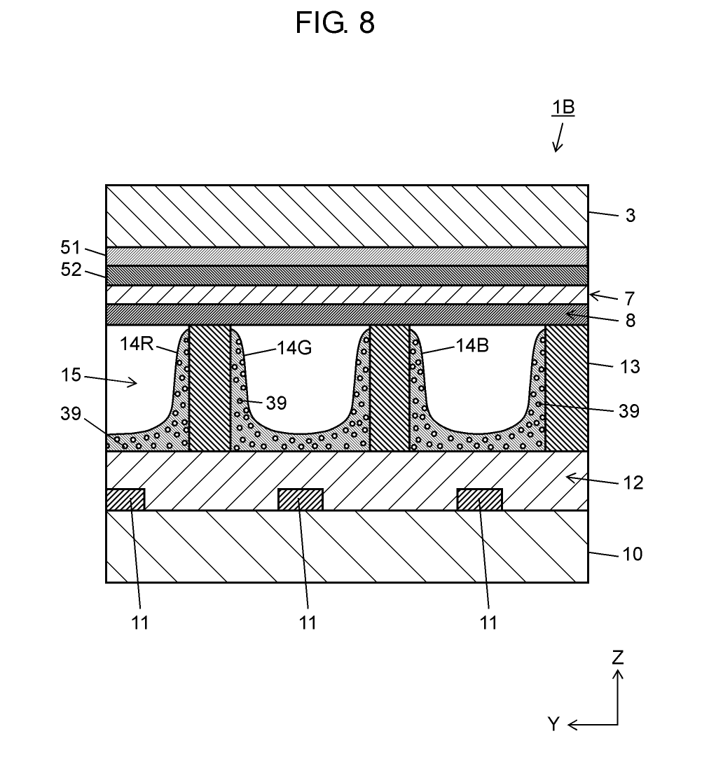

FIG. 8 shows a cross-sectional view of PDP 1B (a mixed-in-phosphor type) according to the second embodiment. The basic structure of PDP 1B is the same as that of PDP1 except for the major feature that adsorbent 39 in an activated state is disposed to be dispersed in phosphor layers 14 (14R, 14G, and 14B). As described above, since phosphor layers 14 (14R, 14G, and 14B) contain a number of voids in the bulk thereof, gases present in discharge spaces 15 can reach adsorbent 39 in phosphor layers 14.

Accordingly, also in PDP 1B having such the configuration, the almost same advantages can be expected as those of PDPs 1 and 1A. That is, adsorbent 39 in the activated state in phosphor layers 14 (14R, 14G, and 14B) effectively adsorbs and removes impurity gases such as H₂O and CO₂ present in discharge spaces 15, thereby keeping the surface of protective film 8 clean. This can suppress the concentration of CO₂ to low concentrations of not larger than 1×10⁻² Pa, in discharge spaces 15 of PDP 1B. As a result, the excellent effect of reducing the discharge voltage is exhibited, leading to an expectation of stable, good image-display performance for the long term.

(Method of Manufacturing PDP 1B)

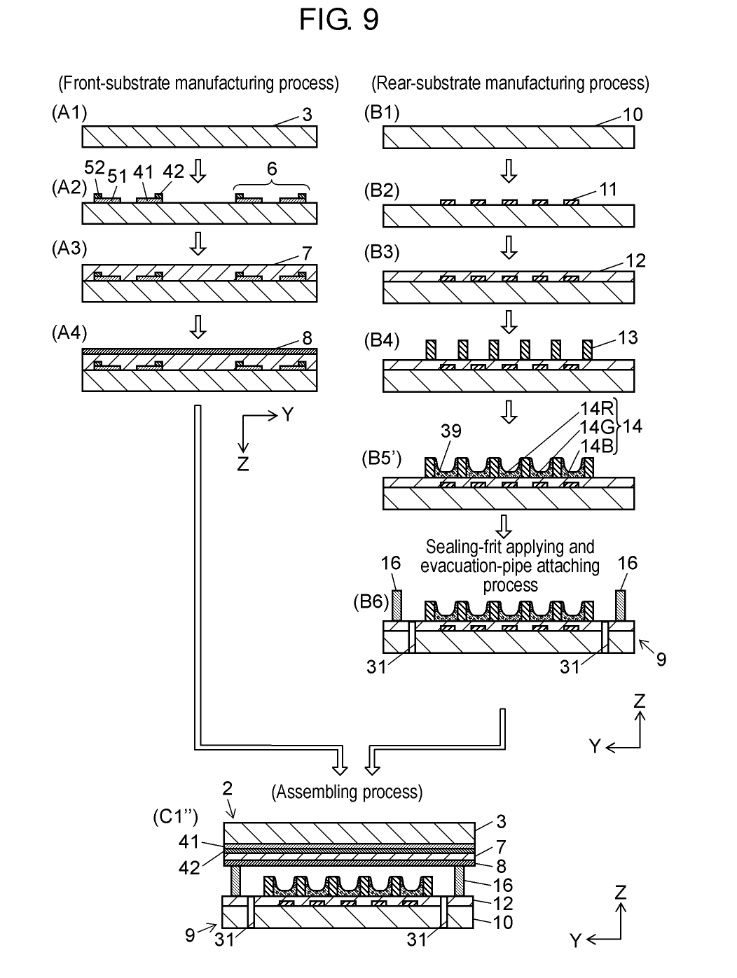

FIG. 9 shows a part of a manufacturing process of PDP 1B. Differences from the manufacturing process of PDP1 are as follows: In the sub-processes of the front-substrate manufacturing process, process A5 is omitted. Moreover, in the sub-processes of the rear-substrate manufacturing process, process B5′ is added between process B4 and process B6. Process B5′ includes an adsorbent disposing process, as a sub-process, in which adsorbent 39 is disposed concurrently with the formation of phosphor layers 14, by applying phosphor materials with adsorbent 39 dispersed therein, on the surfaces of adjacent barrier ribs 13 and on the surface of dielectric layer 12 located between the ribs.

Hereinafter, process B5′ will be specifically described.

First, adsorbent 39 (copper-ion-exchanged ZSM-5 type zeolite) in powder form is added to and mixed with a phosphor ink prepared in process B5 of PDP 1, with the ink containing each of the phosphor materials commonly known. For this mixing, a known method can be exemplified which uses a conventional mixing apparatus. In this case, the mixing ratio is preferably adjusted such that, for an example, the adsorbent component is contained in a range of not smaller than 0.01 wt % and not larger than 2 wt % to the phosphor component, after having completed PDP 1.

Note that the mixing of adsorbent 39 and the phosphors may be carried out in any of a powder state and a paste state.

Next, the thus-prepared ink is applied on the surfaces of adjacent barrier ribs 13 and on the surface of dielectric layer 12 located between the ribs. The resulting product is dried and fired in the same manner as those for PDP 1, thus completing process B5′.

Note that, when applying the ink described above, adsorbent 39 is preferably uniformly dispersed in discharge spaces 15 in the same manner as in the second embodiment, so that the effect of adsorbing the impurity gases can cover all of discharge spaces 15 of PDP 1B. Therefore, if a uniform dispersion is to be obtained, the adsorbent should be carefully well dispersed in the phosphors to be mixed with. However, in some cases, the dispersion in phosphor layers 14 may be not uniform, but may provide a distribution in phosphor layers 14. Since the mixing amount of adsorbent 39 is in a trade-off relationship with an amount of light-emission of the phosphors in operation, it is appropriately adjusted.

After process B5′, process B6 is carried out in the same manner as the manufacturing method of PDP 1. Then, the front substrate 2 and the rear substrate 9 are assembled to overlap and face each other such that display electrode pairs 6 intersect address electrodes 11 at right angles (process C1′). After that, there are sequentially carried out the sealing process, the evacuating process, the discharge-gas introducing process, and the aging process, in the same manner as the manufacturing process of PDP 1A. This completes PDP 1B. In this case, the adsorbent activating process may be carried out in combination with the evacuating process, or may be carried out at any timing after the adsorbent disposing process has been completed, in the same manner as the manufacturing process of PDP 1A. It is possible to arrange the setting conditions of any of the adsorbent activating processes, in the same manner as the manufacturing process of PDP 1A.

(Evaluation Method of the Amount of Impurity Gases in Discharge Spaces)

Next, a method of evaluating the amount of impurity gases in the discharge spaces in a PDP will be described.

In general, the discharge starting voltage of a PDP is subjected to different influences depending on the kinds of gases present in the discharge spaces; therefore, it varies.

In particular, after the PDP has worked for a certain period of time, there are cases where the discharge starting voltage increases due to impurity gases released from any of the constituent elements, e.g. the phosphor layers, which face the discharge spaces.

In this case, the amount of variations in the discharge starting voltage of the PDP due to the impurity gases varies depending on the respective phosphor layers. For this reason, the inventors of the present invention have intensively conducted an examination that includes measurements of chromaticity in a display region with a certain area including a plurality of discharge cells of a PDP, and have found the fact that the variations in the amount of impurity gases appear as variations in chromaticity. Accordingly, it is possible to compare the amounts of impurity gases in the discharge spaces by measuring the amounts of the variations in chromaticity of PDPs.

Hereinafter, a method of evaluating the amount of impurity gases based on the amount of variations in chromaticity will be exemplified by manufacturing Examples and a Comparative Example.

### EXAMPLES

Mini-size PDPs were manufactured and evaluated, where the PDPs had the same specifications including the discharge cell size as those of PDP 1A shown in the second embodiment, except for a display area of 8V-inch.

The discharge gas was a mixed gas of 20% Xe-80% Ne. The sealed-gas pressure was set to 60 kPa.

Specific configurations of the Examples and the method of manufacturing thereof are as follows.

### Example 1

Example 1 has the same configuration as that of PDP 1A of the second embodiment.

As adsorbent 39, the copper-ion-exchanged ZSM-5 type zeolite was used. Powder of adsorbent 39 was mixed to a vehicle of ethylcellulose to prepare a paste which had a relatively-low powder content of adsorbent 39. Specifically, the paste was prepared by mixing: 0.3 wt % of adsorbent, 6.4 wt % of ethylcellulose with a weight-average molecular weight of approximately 200000, and 93.3 wt % of butyl carbitol acetate. The paste was applied on the side surfaces of barrier ribs 13 and the surface area of dielectric layer 12 of whole rear substrate 9, and then dried. After that, an ink containing each of the phosphors was applied to the rear substrate by printing, a commonly known process, and then fired at temperatures of approximately 500° C. to form phosphor layers 14.

Next, the atmosphere of the sealing process for the PDP was set to be N₂ atmosphere as that of FIG. 5.

The other points of the manufacturing method were arranged to be the same as those described in the manufacturing method of PDP 1.

### Example 2

The configuration of Example 2 is the same one as that of PDP 1B of the third embodiment.

Differences from Example 1 are as follows:

A mixed powder was prepared, in advance in powder form, by mixing 0.5 wt % of the adsorbent and 99.5 wt % of the phosphor by using a powder mixer. Then, a paste was prepared by mixing 30 wt % of the resulting mixed powder, 4.5 wt % of ethylcellulose with a weight-average molecular weight of approximately 200000, and 65.5 wt % of butyl carbitol acetate. The paste was prepared for each of the R, G, and B phosphors. Each of the pastes was applied to the rear substrate by printing, a commonly known process, and then fired at temperatures of approximately 500° C. to form phosphor layers 14. Except for this, the other points were arranged to be the same as those of Example 1.

### Comparative Example

A PDP was manufactured, without containing the adsorbent as a difference from Example 1.

(Method of Measuring Variations in Chromaticity)

As described above, the discharge starting voltage of PDP has variations due to impurity gases. The impurity gases are released to the discharge spaces by driving the PDP. A discharge might be generated by the variations of starting voltage in discharge cells which set for displaying of black. And weak light might be generated in the discharge cells. The weak light is visible light which is converted from ultraviolet light by the phosphor layer.

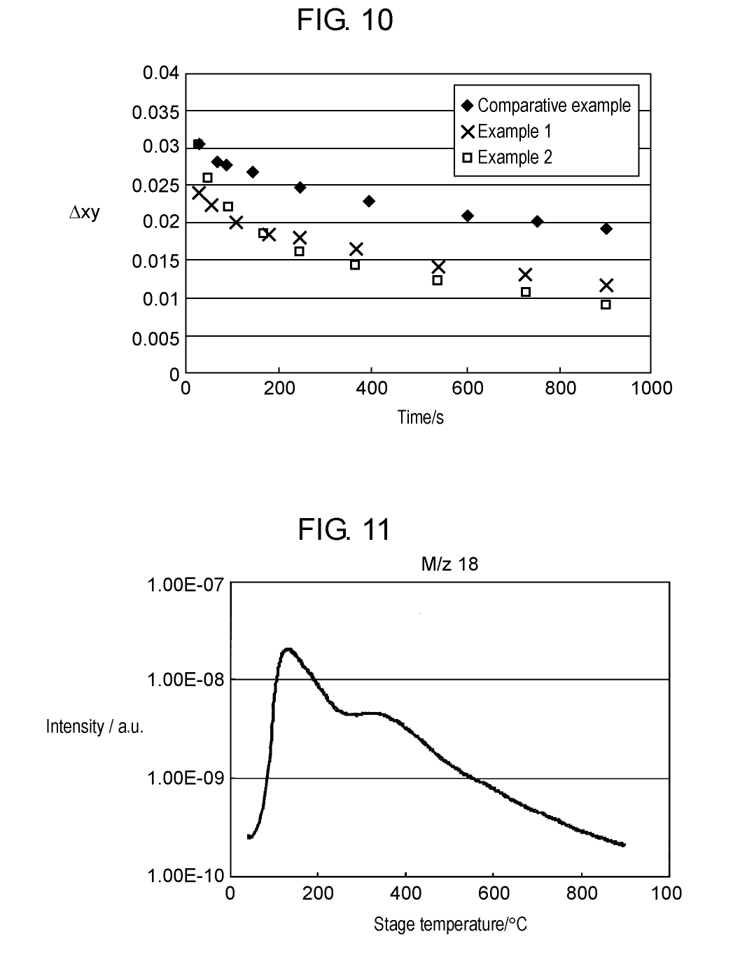

The amount of the variations in the discharge starting voltage of the PDP due to the impurity gases varies depending on the respective color phosphor layers, which thereby changes a color balance of weak light emission, as a whole of the PDP, resulting in variations in chromaticity. Utilizing this phenomenon, for each of thus-manufactured Examples 1 and 2 and the Comparative Example, the amounts of variations in chromaticity were examined as an index showing an amount of the impurity gases. The examinations were made when the PDP was turned off to display black after it had worked for a certain period of time (green color illuminating for 5 minutes). The examination results are shown in the graph of FIG. 10 (the longitudinal axis represents the amount of variations in chromaticity).

(Evaluation of Measurement Results)

As shown in FIG. 10, in all PDPs, the amount of variations in chromaticity shows its maximum just after turning the PDPs off, and then gradually decreases. Since the impurity gases diffuse with time.

In the PDP of Example 1, the effect of the adsorbent has been confirmed in terms of the decrease in the amount of the impurity gases present in the discharge spaces, i.e. the amount of variations in chromaticity has been kept smaller consistently during a period of 900 seconds immediately after turning the PDP off by disposing the adsorbent in a space communicatively connected with the discharge spaces.

Moreover, in the PDP of Example 2, the effect of the adsorbent has also been confirmed in terms of the reduction in the amount of the impurity gases present in the discharge spaces, i.e. use of the adsorbent can suppress the variations in chromaticity to be small.

In the configuration of the second embodiment, it has also been confirmed that the increase in weight ratio of the adsorbent in the paste up to 1 wt % reduces the amount of variations in chromaticity down to 0.0088, 900 seconds after the turning-off, and increases the effect of adsorbing the impurity gases in the discharge spaces, in proportion to the amount of the disposed adsorbent.

Moreover, in the configuration of the third embodiment, it has also been confirmed that the increase in weight ratio of the adsorbent in the phosphors up to 2 wt % reduces the amount of variations in chromaticity down to 0.006, 900 seconds after the turning-off, and increases the effect of adsorbing the impurity gases in the discharge spaces, in proportion to the amount of the disposed adsorbent.

Note that, since the copper-ion-exchanged ZSM-5 type zeolite is capable of adsorbing Xe, an excessive introduction of the zeolite into the discharge spaces causes a decrease in the efficiency due to Xe adsorption. Therefore, the amount of the introduced zeolite must be optimized. The optimized amount is necessary to be adjusted in accordance with the size of PDP, the amount of released impurity gases, the concentration of Xe, and the like.

(Evaluation of Activated State of Adsorbent)

In order to examine activated states of the copper-ion-exchanged ZSM-5 type zeolite used as adsorbent 39 in the present invention, specimens were subjected to the sealing process and the evacuating process that were the same as the manufacturing process in the second embodiment.

After that, adsorbent 39 of the specimens was exposed to the atmosphere for 5 minutes or more. Then, the specimens were measured with a thermal desorption spectrometer (TDS) in terms of the amounts of H₂O and CO₂ that were released as desorbed gases at arbitrary temperatures by heating, with these gases having been adsorbed from the atmosphere. The TDS was a TDS1200 manufactured by ESCO Ltd. The achieving temperature of a stage was set to be within up to 900° C., and the rate of temperature rise was set to 20° C./minute. Moreover, a holder and dropping-cap composed of SiC was used in the measurement.

The measurement results are shown in FIG. 11 (the amount of adsorbed H₂O when adsorbed from the atmosphere), and in FIG. 12 (the amount of adsorbed CO₂ when adsorbed from the atmosphere). In FIGS. 11 and 12, the lateral axis represents the temperature of the stage on which the specimens (adsorbents 39) were placed, and the longitudinal axis represents observed intensity (in an arbitrary unit) of the desorbed gas of each ion species.

In both graphs shown in FIGS. 11 and 12, remarkable peaks are observed at the stage temperature of around 140° C. (the specimen temperature of approximately 80° C. to 100° C.) and at the stage temperature of around 350° C. (the specimen temperature of approximately 210° C. to 230° C.). It is understood that the former are peaks associated with physically-adsorbed gases, while the latter are peaks associated with chemically-adsorbed gases. This reaches an understanding that the both gases, H₂O and CO₂, had been trapped in the adsorbent by the both actions of physical adsorption and chemical adsorption. Accordingly, it can be confirmed that, after having undergone the sealing process and the evacuating process, adsorbent 39 is in the state where it exhibits both characteristics of physical adsorption characteristics and chemical adsorption characteristics, i.e. adsorbent 39 is in a highly activated state.

Through the respective experiments described above, the superiority of the present invention is confirmed.

(Other Items)

In the embodiments, adsorbent 39 is exemplified by the copper-ion-exchanged ZSM-5 type zeolite. This adsorbent 39 can adsorb impurity gases very well; however, adsorbent 39 used in the present invention is not limited to this. Other than this, any adsorbent 39 can be used as long as it is capable of holding its adsorption activity for impurity gases and capable of adsorbing and desorbing Xe. As a specific example, a copper-ion-exchanged zeolite of MFI type, BETA type, or MOR type can be exemplified. Moreover, a mixture of these zeolites may be used as adsorbent 39.

Moreover, the method described above of manufacturing each of the PDPs can be used in a wide range of applications including a high-definition PDP and an ultrahigh-definition PDP as well as usual PDPs. In particular, the method is effective in driving a high-definition or ultrahigh-definition PDP, with good light-emission efficiency for the long term (particularly, the PDP is such that its cell pitch is not larger than 150 μm, leading to a large occupied volume of members facing discharge spaces 15).

A conventional technique, which getters in the tip-pipe attached to a PDP are used for adsorbing impurities, is known.

However, the first embodiment is greatly different from the conventional technique in that the copper-ion-exchanged zeolite, not the getter, is used as adsorbent 39 and adsorbent 39 is disposed to be dispersed on the surface of protective film 8. Furthermore, the second embodiment is greatly different from the conventional technique in that adsorbent 39 is disposed in the space between phosphor layers 14 and at least one of barrier ribs 13 and dielectric layer 12. The third embodiment is also greatly different from the conventional technique in that adsorbent 39 is disposed to be dispersed in phosphor layers 14.

Moreover, when using the getters, it is gradually pulverized into powder caused by the adsorption of impurity gases, leading to a possible scattering of the powder in the discharge spaces. In contrast, in the first to third embodiments, the use of the copper-ion-exchanged zeolite as adsorbent 39 does not result in pulverization thereof, even if it adsorbs at least impurity gases.

In the manufacturing method of the first to third embodiments, although the sealing process and the evacuating process have been exemplified by the cases where they are carried out under the environments at relatively high temperatures for a long period of time, the present invention is not limited to these settings as a matter of course. That is, it is also possible to carry out at least one of the sealing process and the evacuating process for a shorter period of time or at lower temperatures. Moreover, it is also possible to control the sealing process and the evacuating process such that the processes are carried out in a vacuum (a reduced pressure) atmosphere throughout the processes.

### INDUSTRIAL APPLICABILITY

The PDP and the method of manufacturing thereof according to the present invention are useful in manufacturing TV receivers and display terminals of computers used in transportation facilities, public facilities, households, etc., as a technology of, in particular, a high-definition image display with low power consumption. In any application, they are useful in viewpoints of a low discharge sustaining voltage in the initial stage and a small time-dependent variation of the discharge sustaining voltage. In particular, being highly applicable to next-generation high-definition PDPs, they can feature excellent industrial applicability.

### REFERENCE MARKS IN THE DRAWINGS

1, 1A, 1B PDP
2 front substrate (front panel)
3 front substrate glass
4 scan electrode
5 sustain electrode
6 display electrode pair
7, 12 dielectric layer
8 protective film
9 rear substrate (back panel)
10 rear substrate glass
11 address (data) electrode
13 barrier rib
14 (14R, 14G, 14B) phosphor layer
15 discharge space
16 sealing material
31 tip-pipe (evacuation-pipe) attaching hole
39 adsorbent
41, 51 transparent electrode
42, 52 bus line
111 scan electrode driver
112 sustain electrode driver
113A, 113B data electrode driver

1. A plasma display panel comprising:
a front substrate including;
a plurality of display electrode pairs formed on a surface of the front substrate,
a first dielectric layer formed to cover each of the display electrode pairs, and
a protective layer formed on the first dielectric layer, and
a rear substrate including;
a plurality of data electrodes formed on a surface of the rear substrate,
a second dielectric layer formed to cover each of the data electrodes,
a plurality of barrier ribs formed on the second dielectric layer, and
a phosphor layer formed one of directly and indirectly on side surfaces of the barrier ribs and on a surface of the second dielectric layer,
the front substrate and the rear substrate being disposed via a discharge space such that a face on which the protective layer is formed confronts a face on which the barrier ribs formed thereon, the discharge space being filled with a discharge gas,
wherein
a copper-ion-exchanged zeolite adsorbent is disposed in one of the discharge space and a space permeable to the discharge space, and
the adsorbent is in a activated state.

2. The plasma display panel of claim 1, wherein a concentration of CO₂ in the discharge space is adjusted to be not larger than 1×10⁻² Pa.

3. The plasma display panel of claim 1, wherein the adsorbent is a zeolite of any one of ZSM-5 type, MFI type, BETA type, and MOR type.

4. (canceled)

5. (canceled)

6. The plasma display panel of claim 1, wherein the adsorbent is dispersed in the phosphor layer, and a weight ratio of a component of the adsorbent to a component of the phosphor layer is in a range of not smaller than 0.01 wt % and not larger than 2 wt %.

7. (canceled)

8. The plasma display panel of claim 1, wherein the adsorbent is disposed on a surface of the protective film, wherein a coverage factor of the adsorbent to the surface of the protective film is not larger than 20%.

9. (canceled)

10. (canceled)

11. (canceled)

12. A method of manufacturing a plasma display panel, the method comprising:
forming a front substrate,
forming a rear substrate,
assembling the front substrate and the rear substrate to overlap each other via a sealing material,
sealing the assembled front substrate and the assembled rear substrate,
evacuating a space between the assembled front substrate and the assembled rear substrate, and
introducing a discharge gas into a discharge space between the front substrate and the rear substrate,
wherein
at least one of the step of forming the front substrate and the step of forming the rear substrate includes a step of disposing a copper-ion-exchanged zeolite adsorbent in one of the discharge space and a space communicatively connected with the discharge space.

13. (canceled)

14. (canceled)

15. (canceled)

16. (canceled)

17. The method of claim 12, the method further including;
a step of activating the adsorbent to an activated state after the step of disposing the adsorbent, wherein the step of activating the adsorbent is carried out in combination with the step of evacuating.

18. (canceled)

19. (canceled)

20. (canceled)

21. (canceled)

22. The method of claim 12, wherein
the step of forming the front substrate includes;
forming a plurality of display electrode pairs on a surface of a front substrate glass, and a first dielectric layer covering each of the display electrode pairs, and
forming a protective layer on the first dielectric layer, and
the step of forming the front substrate includes the step of disposing the adsorbent on a surface of the protective film, wherein the step of sealing is carried out in a nonoxidizing gas atmosphere, and the step of evacuating is carried out in a nonoxidizing gas atmosphere at a reduced pressure.

23. (canceled)

24. (canceled)

25. (canceled)

26. (canceled)

27. (canceled)

28. (canceled)

29. (canceled)

30. (canceled)

31. (canceled)
